(19) United States
(12) Patent Application Publication
(10) Pub. No.: US 2010/0301624 A1
(43) Pub. Date: Dec. 2, 2010

(54) MODULAR TRAILER FLOORING

(76) Inventors: Andrew P. Boos, Skaneateles, NY (US); Daniel E. Pajak, Skaneateles, NY (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/473,860

(22) Filed: May 28, 2009

(51) Int. Cl. B60P 3/14; B60R 11/06

(52) U.S. Cl. 296/24.32

(57) ABSTRACT

A service truck or trailer includes a moveable floor portion which can be slideable moved forwardly to expose an open area below into which an operator can stand in order to provide access to and use of machinery and/or tools installed in the vehicle.

### TECHNICAL FIELD

This invention relates generally to vehicles and, more particularly, to a truck/trailer having a moveable floor section that provides easy access to a workspace for operating shop equipment within the trucks interior.

### BACKGROUND OF THE INVENTION

It is common for contractors and other skilled professionals in the construction, installation and repair business to outfit the back of their trailer or truck to include all of the machinery and tools that they are likely to need on the job site. The back of the truck may be open with access to the machinery/tools being gained by walking around the truck. Alternatively, the machinery/tools may be entirely located within the truck, with access being gained by the contractor climbing into the truck. Where access is gained externally, not only is the equipment exposed to the elements, but the operator is also exposed while gaining access and possibly while using the equipment. When the equipment/tools are located within the truck, there is generally very little room for the operator to move around. That is, it is first necessary to climb up into the truck and then, there is generally insufficient headroom to stand upright within the truck.

In addition to the inconveniences as described hereinabove, the common service truck does not include various shop related devices, such as an anvil, a vise, a forge, and power devices such as a drill press, a grinder, and the like.

What is needed is a truck/trailer which is outfitted with the necessary equipment/tools that are easily accessible by an operator in such a way as to be used without exposure to the outdoor elements.

### DISCLOSURE OF THE INVENTION

Briefly, in accordance with one aspect of the invention, a truck/trailer includes a floor, a portion of which is moveable to thereby expose an area below, such that an operator may stand in that area to gain access to and use of the various equipment/tools in the truck.

By another aspect of the invention, a floor panel is slideably storable in a forward position to thereby provide an open space for the operator to stand and to conduct his work.

### BRIEF DESCRIPTION OF THE DRAWINGS

FIG. 1 is a perspective view of the present invention as incorporated into a truck rear body.

FIG. 2 is a perspective view of the floor panel thereof in the closed position.

FIG. 3 is a perspective view of the floor section thereof in the open position.

FIG. 4 is a perspective view of the open area with an operator occupying the space.

FIG. 5 is a perspective view of the interior of the truck showing certain features thereof.

FIG. 6 is a perspective view of the floor panel and its supporting structure in accordance with the present invention.

### DETAILED DESCRIPTION OF THE INVENTION

The invention is generally shown at 10 as incorporated into a rear body 11 of a trailer, the rear body 11 having side walls 12, a rear wall 13, a top wall 14 and a floor 16. On each side wall 12 there is a door 17 that is moveable to an open position as shown to provide access to the inside as shown and also for the purpose of providing ventilation through the interior of the rear body 11. A rear wall door 18 is moveable to an open position as shown to provide access to the interior of the rear body 11 by way of a rear entry.

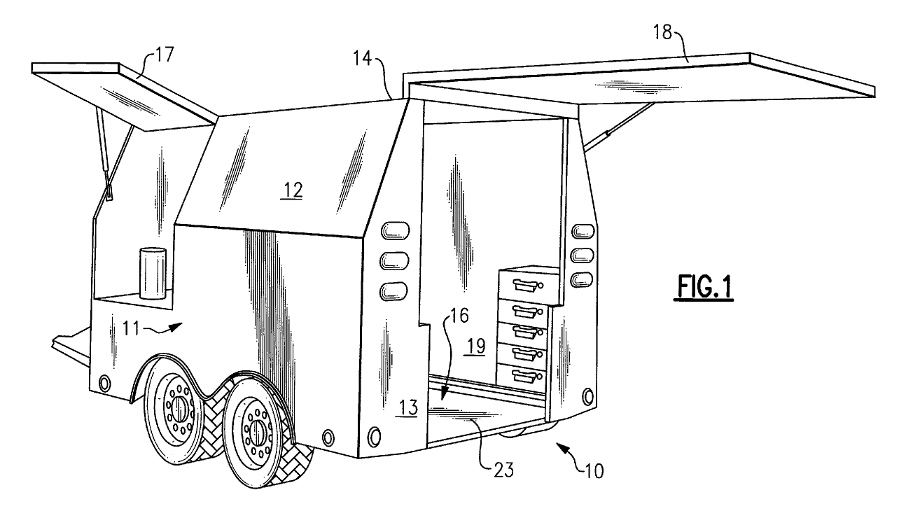

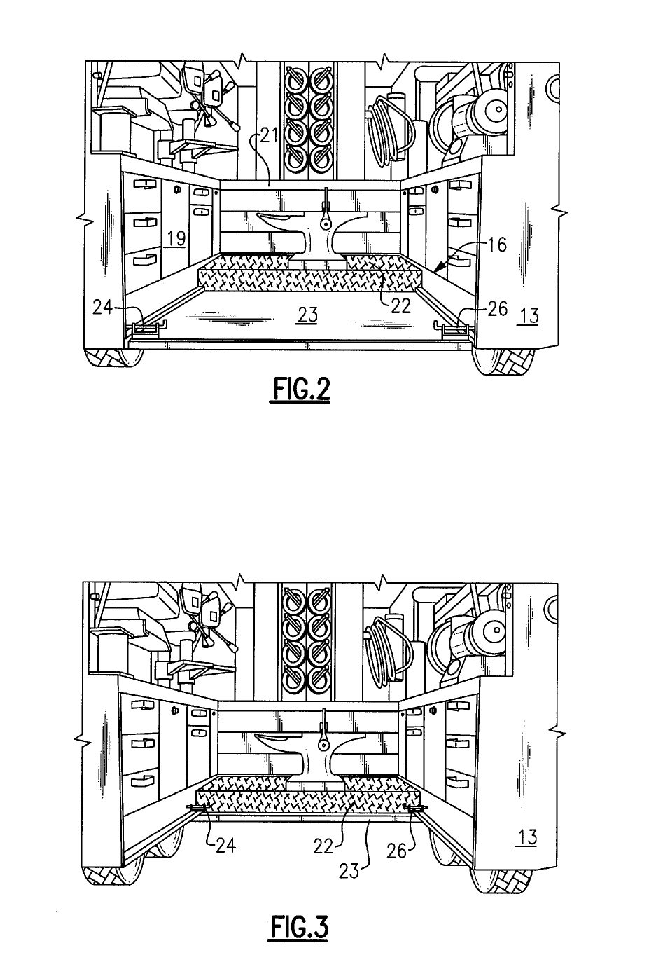

As shown in FIG. 1 and FIG. 2, located within the rear body 11, on the sides and front portions thereof, are a plurality of cabinets/drawers for the containment of tools and the like, and on the top of which is a counter 21 to serve as a workspace and a platform for the installation of various equipment/tools as will be more fully described hereinafter. Although the equipment shown is designed for a farrier, it may be adapted for use by any particular type of professional. The floor 16 includes a fixed portion 22 and a moveable portion 23. The floor moveable portion 23 is shown in a closed position in FIG. 2 and in a moved or open position in FIG. 3. As will be seen in FIG. 2, a pair of lock pins 24 and 26 are provided to lock the moveable portion 23 in the closed position by way of engagement with the rear wall 13. During most times, the moveable portion is in the closed position with the lock pins 24 and 26 engaged. At such times, the rear wall door 18 can be opened, and the user can step up into the interior of the rear body 11 so as to stand on the fixed portion 22 and/or the moveable portion 23. However, if he wishes to have more head room and/or to be at a more convenient elevation with respect to the counter 21, he may move the moveable portion 23 to the open position as shown in FIG. 3. To accomplish this he simply needs to release the lock pins 24 and 26 and slide the moveable portion 23 forwardly to a position under the fixed portion 22 as shown. The inter-relationship between those two structures is more fully described hereinafter.

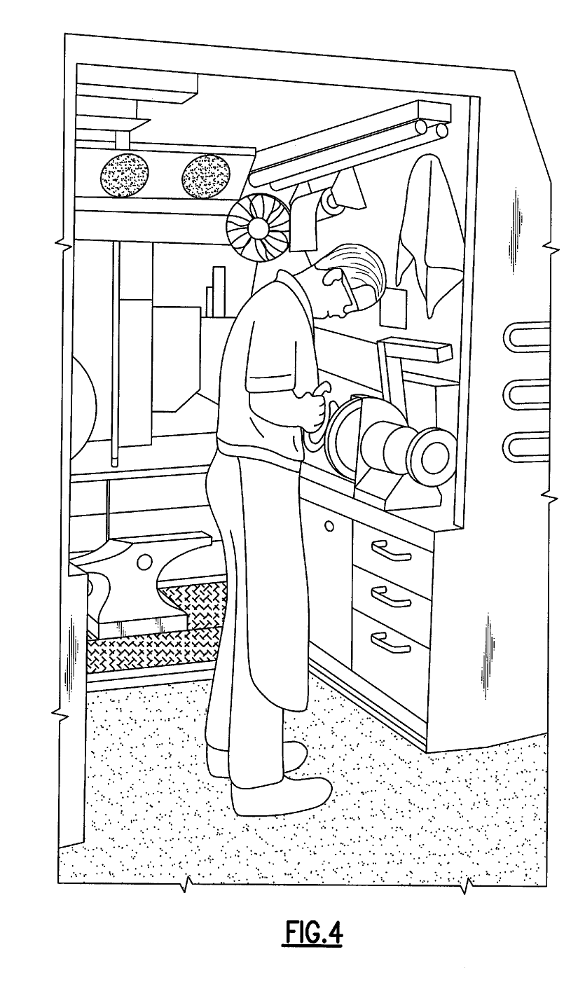

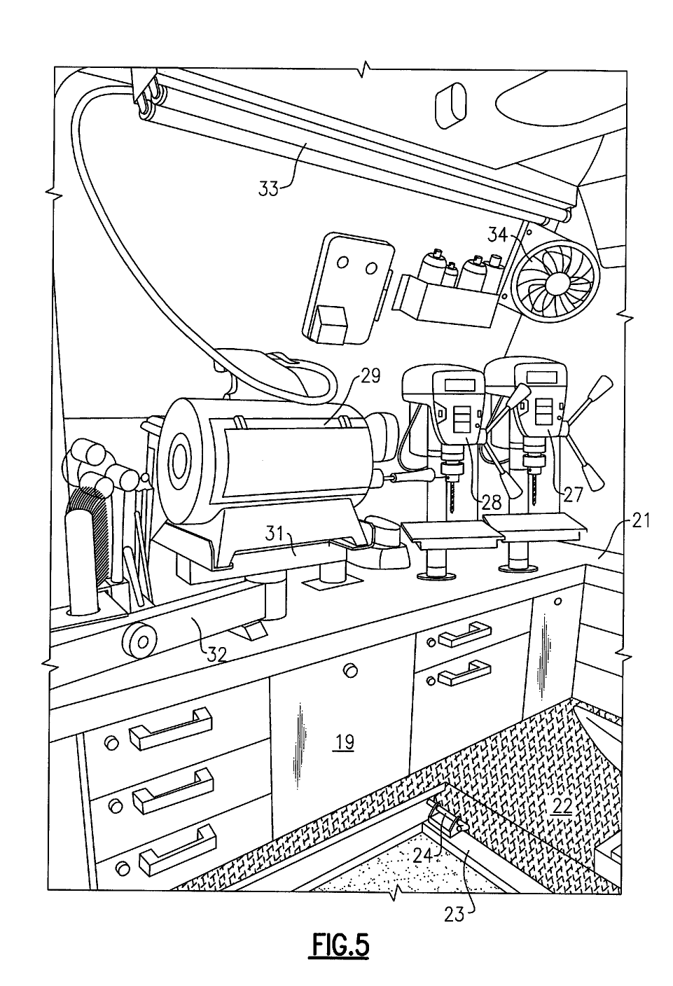

In FIG. 4, there is shown a view of the moveable portion 23 as being in the open position with a user standing on the ground below the space previously occupied by the moveable portion 23, so as to be in a convenient position for operating equipment located on the counter 21.

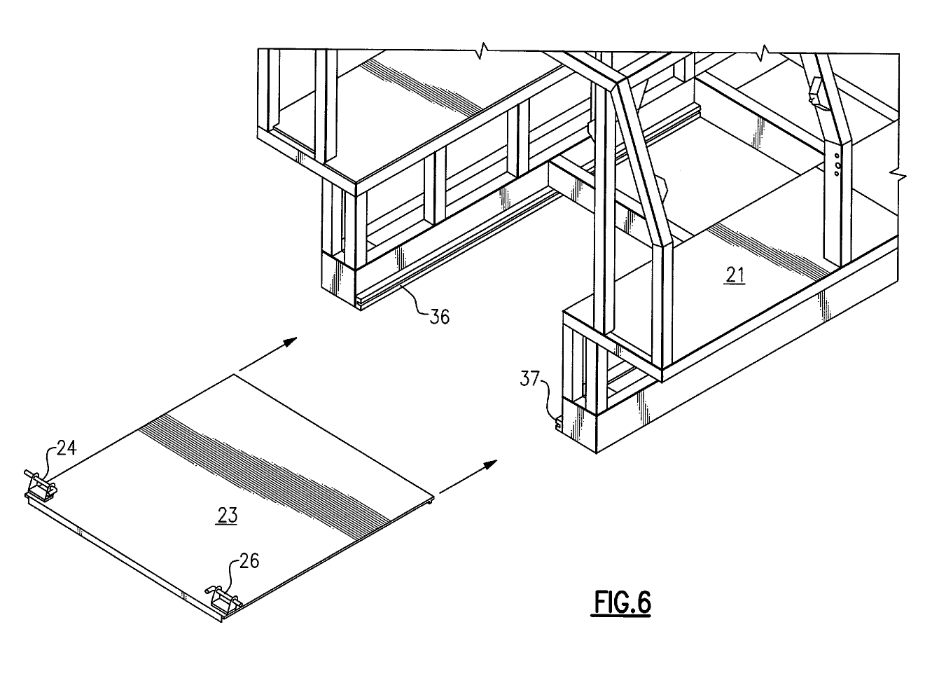

In FIG. 5, there is shown an internal view of the rear body 11 with its contained cabinets/drawers 19 and counter 21. The moveable portion 23 is in the open position to expose the ground therebelow, and on which the operator can stand while operating various equipment within the rear body 11. Such equipment includes a pair of drill presses 27 and 28, and a forge 29. The forge 29 is mounted on a frame 31 which is, in turn, rotatably mounted on a swingable arm 32. The swingable arm 32 can be swung out to the open area created by the open moveable portion 23, with the forge 29 then being located above that space such that the operator can stand on the ground and easily work with the forge 29. It will, of course, be understood that various other types of useful equipment can be so mounted and used in this manner. Alternatively, the equipment can remain in place over the counter 21, with the operator standing in the open space and using the equipment in that position. Equipment can also be placed on the fixed portion 22 such that the operator can conveniently stand next to it for use. For that purpose, an anvil is shown as installed on the fixed portion in FIGS. 2 and 3.

Power to the power equipment located in the rear body 11 can be provided by a generator or alternator driven by the vehicle engine or by way of a separate, stand-alone generator located within the rear body 11. One such installation would include a generator that is driven by an engine operating on propane gas. Such a generator would also power the lights 33 and ventilation fans 34 as shown. One or both of the side doors 17 can also be opened as shown to improve ventilation through the interior of the rear body 11.

Referring now to FIG. 6, the lower moveable portion 23 is shown in the disassembled or removed position. In accordance with the present invention, the moveable portion can be moved to any of various locations, so long as it opens up the space below for the user to stand on. For example, it may be simply pulled rearwardly and removed from the rear body 11 entirely such as in the position shown. Or it may be simply lowered to rest on the ground or other supporting surface below the rear body, with the operator then standing on the top surface thereof. If one chooses to have it storable under the fixed portion 22 as shown in FIG. 3, this can be simply accomplished by the mounting of the moveable portion 23 in a pair of spaced tracks 36 and 37.

Although the moveable portion 23 of the floor is shown at the rear of the truck, and with a fixed portion 22 forward thereof, other arrangements are possible while remaining within the scope of the present invention. For example, depending on the particular equipment and use within the truck body, the moveable portion 23 may be in an intermediate or front portion of the truck rear body, and it may be moved to any convenient location such as rearwardly.

It should also be understood that, while the present invention has been described as installed in a rear body of a trailer, it can also be stored in a truck or a van, for example.

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. A mobile enclosure having side walls, a ceiling and a floor for containing various types of equipment and/or tools; wherein at least a portion of the floor is moveable so as to expose an area below for entry and occupancy by an operator of the equipment/tools.

2. A mobile enclosure as set forth in claim 1 wherein the enclosure includes a rear door and further wherein said moveable portion is located near said rear door.

3. A mobile enclosure as set forth in claim 1 and including a supporting slide structure on either side of said moveable portion such that said moveable portion is opened or closed by sliding said movable portion with respect to said slide structures.

4. A mobile enclosure as set forth in claim 3 wherein said floor includes a fixed portion and further wherein said moveable portion can be opened by sliding it under said fixed portion.

5. A mobile enclosure as set forth in claim 1 and including a counter disposed vertically above said floor and having a plurality of power tools installed thereon.

6. A mobile enclosure as set forth in claim 5 and including a generator for generating power for use by said power tools.

7. A mobile enclosure as set forth in claim 1 and including one or more fans disposed in said enclosure for circulating the air therein.

8. A mobile enclosure as set forth in claim 1 and including at least one opening in a side wall for access and/or ventilation purposes.

9. A method of providing access to the interior of a mobile enclosure adaptable for containing equipment and/or tools, comprising the steps of:
providing a floor for the enclosure, a portion of which is moveable from a closed position to an open position; and
when access to the enclosure interior is desired, moving said moveable portion to an open position so as expose an area below for entry and occupancy by an operator.

10. A method as set forth in claim 9 and including the step of providing in the enclosure a rear door that can be opened to gain access to said moveable portion.

11. A method as set forth in claim 9 and including the step of providing a supporting slide structure on either side of said moveable portion such that said moveable portion can be opened or closed by sliding said movable portion with respect to said slide structure.

12. A method as set forth in claim 11 wherein said floor includes a fixed portion and further wherein said moveable portion can be opened by sliding it under said fixed portion.

13. A method as set forth in claim 9 and including the step of providing an elevated counter around the floor, said counter having a plurality of power tools installed thereon.

14. A method as set forth in claim 13 and including the step of providing a generator for generating power for use by said power tools.

15. A method as set forth in claim 9 and including the step of providing one or more fans in said enclosure for circulating the air therein.

16. A method as set forth in claim 9 and including the step of providing at least one opening in a side wall for access and/or ventilation purposes.
